(19) United States
(12) Patent Application Publication
(10) Pub. No.: US 2026/0106456 A1
(43) Pub. Date: Apr. 16, 2026

(54) METHOD FOR CONTROLLING A POWER SOURCE

(71) Applicant: INNIO Jenbacher GmbH & Co OG, Jenbach (AT)

(72) Inventors: Ingo Walch, Absam (AT); Johannes Huber, Kramsach (AT); Tobias Keller, Innsbruck (AT); Stefan Jakubek, Wien (AT); Martin Kozek, Wien (AT)

(21) Appl. No.: 19/120,746

(22) PCT Filed: Oct. 12, 2022
(86) PCT No.: PCT/AT2022/060352

§ 371 Date: Apr. 11, 2025

(51) Int. Cl. H02J 3/0014; H02J 3/38; H02J 3/40; H02J 101/10; H02J 103/35

(52) U.S. Cl. CPC H02J 3/00142; H02J 3/381; H02J 3/40; H02J 2101/10; H02J 2103/35

(57) ABSTRACT

Method for controlling at least one power source (1), the at least one power source (1) supplying electrical power to at least one power consumer (3) via an electrical power supply grid (2), wherein the following steps are carried out:
measuring and/or determining electrical quantities, preferably a frequency and a power disturbance, of the power supply grid (2) during a time period where the electric power supply grid (2) is excited and/or perturbed, such that there is a frequency deviation from a nominal frequency of the power supply grid,
deriving at least one parameter (H,D,K_{P},K_{I},K_{D}) of a dynamic grid response model from measured values and/or determined values of the measurement and/or determination of the electrical quantities of the power supply grid (2), and
adapting a control algorithm defining a control response of the at least one power source (1) depending on the at least one parameter (H,D,K_{P},K_{I},K_{D}) of the dynamic grid response model.

### CROSS-REFERENCE TO RELATED APPLICATION

This application is a National Stage entry from, and claims benefit of, PCT Application No. PCT/AT2022/060352, filed on Oct. 12, 2022, entitled “METHOD FOR CONTROLLING A POWER SOURCE”, which is herein incorporated by reference in its entirety.

### BACKGROUND

The present invention is concerned with a method for controlling at least one power source, which supplies power to at least one power consumer via an electrical power supply grid. The invention is furthermore concerned with a system having a classifying portion and a power source, in particular a genset, for generating electric power.

When power supply grids experience state changes in the balance between generated power and consumed power certain, the frequency or voltage of the grid can change, typically in a temporary manner.

Different power supply grids naturally react differently to such perturbations and excitations. The prior art knows the so-called Swing Equation, which describes the frequency change Δf in terms of the sum of the generated power P_{M}, the sum of the consumed power P_{L} and constants H and D (in normalised form) as follows:

$$\frac{d Δ f}{dt} = \frac{1}{2 H} ( \sum {P}_{M} - \sum {P}_{L} - D Δ f$$

The constant H is interpreted as the grid inertia time constant, typically the inertia of rotating masses of gensets, gas turbines, or generators. The constant D is a load damping parameter.

The inertia constant H can be defined as:

$$H = \frac{1}{2} \frac{{J ( 2 π {f}_{0} )}^{2}}{{S}_{N}}$$

and can be interpreted as the stored kinetic energy in all rotating masses in the grid, normalized to an apparent power base S_{N}.

Background information can be found in Prabha Kundur, “Power System Stability and Control”, McGraw-Hill, 1994.

WO 2015/067602 A2 discloses a method for measuring frequency response characteristics of a power supply grid using frequency modulation devices, in particular an inertia and a stiffness, although it is unclear from that disclosure if these parameters are in fact the inertia and damping parameters mentioned before.

In any case, power sources are of course influenced by dynamic states of the grid. In particular, frequency changes have a direct effect on generators and consequently also on the drives of generators, such as gas engines. Additionally, power sources are required to contribute to bringing the power supply grid back to a desired steady state when a perturbation or excitation of the power supply grid occurs.

In “Nonlinear model predictive control of an internal combustion engine exposed to measured disturbances” Huber, Kopecek, and Hofbaur present a control approach for an internal combustion engine, which can effectively deal with disturbances based on an engine model and a model predictive controller (Control Engineering Practice 44 (2015) 78-88).

### BRIEF DESCRIPTION

An aspect of the invention is to provide a method and a computer program product for controlling a power source or a system comprising at least one power source in an improved manner. The aspect of the invention is furthermore to provide the system, the power source, and a method for operating the power source.

Regarding the method for controlling at least one power source, the aspect is attained with the features described herein, wherein the at least one power source supplies electrical power to at least one power consumer via an electrical power supply grid and the following steps are carried out:
measuring and/or determining electrical quantities, preferably a frequency, of the power supply grid during a time period where the electric power supply grid is excited and/or perturbed, such that there is a frequency deviation from a nominal frequency of the power supply grid,
deriving at least one parameter of a dynamic grid response model from measured values and/or determined values of the measurement and/or determination of the electrical quantities of the power supply grid, and
adapting a control algorithm defining a control response of the at least one power source depending on the at least one parameter of the dynamic grid response model.

Regarding the methods claimed herein, it should be pointed out that it is of course possible to carry out further method steps.

Regarding the system, the aspect is attained by the features described herein, namely in that the system comprises:
at least one power source, in particular a genset, for producing electrical power, wherein the at least one power source is configured for being connected to an electric power supply grid, and wherein the at least one power source includes a control unit capable of controlling the operation of the at least one power source,
a measuring device configured for measuring and/or determining electrical quantities of the power supply grid during a time period, where the power supply grid is excited and/or perturbed, such that there is a frequency deviation from a nominal frequency of the power supply grid, and
a computing device which is configured for receiving measured values and/or determined values from the measuring device and for outputting data to the at least one power source,
   wherein the computing device is configured to:
derive at least one parameter of a dynamic grid response model from the measured values and/or the determined values of the measurement and/or the determination of the electrical quantities of the power supply grid and/or from electrical quantities of the power supply grid determined otherwise, and
output the at least one parameter and/or instructions for an adapted control of the at least one power source based on the at least one parameter of the dynamic grid response model to the control unit of the at least one power source.

In preferred embodiments, the system is capable of performing the method according to embodiments of the invention.

Regarding the power source, in particular a genset, for generating electric power the aspect is attained with the features described herein, namely in that the power source comprises an engine for driving a generator by combusting a fuel and a control unit for the engine and/or the generator, wherein the control unit is adapted to receive as input:
at least one parameter of a dynamic grid response model, and/or
instructions for an adapted control of the at least one power source based on the at least one parameter of the dynamic grid response model,
   and wherein the control unit is further configured to adapt the control of the engine and/or the generator based on the at least one parameter of the dynamic grid response model and/or the instructions.

The power source according to embodiments of the invention can be used in the system according to embodiments of the invention, or for carrying out the methods according to the embodiments of invention.

Regarding the computer program product for controlling the at least one power source, the aspect is attained with the features described herein, namely by instructions which cause an executing computer to perform the following functions:
from a measuring device receiving measured values and/or determined values of electrical quantities of the power supply grid during a time period where the power supply grid is excited and/or perturbed, such that there is a frequency deviation from a nominal frequency of the power supply grid, and
deriving at least one parameter of a dynamic grid response model from the measured values and/or the determined values of the measurement and/or determination of the electrical quantities of the power supply grid, and
adapting a control algorithm defining a control response of the at least one power source depending on the at least one parameter of the dynamic grid response model.

The executing computer can, for example, be the computing device of the system according to the embodiments of invention or the control unit of the power source according to the embodiments of invention.

Protection is also sought for a data storage device, preferably non-transitory, with a computer program product according to embodiments of the invention stored thereon.

The power supply grid is sometimes simply called grid in the following discussion.

The dynamic grid response model can be understood as a dynamic model in the sense of system theory, i.e., the model can be viewed as one or more differential equations modelling the grid and/or its participants.

A basic aspect of the invention is the idea to use the dynamic grid response model or the at least one parameter thereof to enable the controller of the power source to react to disturbances in the grid commensurate with the properties of the grid. In a simple example, the controller could react more aggressively for compensating a disturbance in a grid with less inertia, and vice versa.

Formulated differently, a basic idea of embodiments of the invention is to identify the properties of the grid by identifying the at least one parameter of the dynamic grid response model. Once the properties or the model are identified, the controller of the power source can be adapted.

One advantage of embodiments of the invention is, therefore, that individual power sources can be controlled in an improved manner. It should, however, be noted that also power consumers may be controlled better with the knowledge of accurate grid response characteristics.

The power supply grid can comprise other participants, e.g., for regulating and/or controlling the grid. The at least one power source, the at least one power consumer, and the other participants are collectively referred to as the participants.

The at least one power source can comprise a genset and/or an internal combustion engine for a genset. A genset is understood to be a generator driven by an internal combustion engine, in particular, a gas engine. The gas engine can be driven by different gaseous fuels, such as molecular hydrogen, natural gas, methane, or other hydrocarbons. Gensets are also known as gas engine power plants.

The at least one power source can comprise other power sources, such as gas turbines or other drivers (e.g., wind, water, steam) coupled to generators, or other power sources such as photovoltaic power or battery storage systems.

In preferred embodiments, the power supply grid is a so-called island network or microgrid or weak grid, which can be understood to mean a relatively small power supply grid with a relatively small amount of power sources, preferably less than 20, 10, or 5, and/or a relatively small amount of power consumers, preferably less than 20, 10, or 5.

In other embodiments, the power supply grid can be a public power grid, e.g., stretching over a country or continent.

The power supply grid can preferably be a synchronous AC grid.

The power supply grid can have a preferably essentially constant frequency when it is not excited and/or perturbed.

The essentially constant frequency can be a nominal frequency of the power supply grid.

The adaption of the control of the at least one power source and/or the engine and/or the generator based on the at least one parameter and/or the instructions can be performed, so that the adaption is permanent, for example, until the next time the grid response characteristic is estimated. In other embodiments, the adaption can be performed when a perturbation or excitation of the power supply grid is detected.

The control unit can be part of the power source or can be embodied separately from the power source, in particular, the genset.

The control unit is configured to implement a control of the power source, in particular, the genset.

The control of the power source can preferably be a cascaded control, where higher level controls give desired control values to lower level control, which can for example directly output command values to actuators of the power source, in particular, the genset or the engine of the genset.

The control of the power source or its higher level, intermediary level, or lower-level controls can be open or closed loop controls.

The electrical quantities can be measured and/or determined from the power supply grid directly or, for example, from the at least one power source and/or the at least one power consumer.

For example, a grid frequency can be measured at a generator.

For example, a change of power can be determined from the change of generated or consumed power. A change of mechanical power output of an engine of a genset, for example caused by forcing certain actuators, can for example be used to determine a change of power generated by the genset. As mentioned below, this can be used to actively excite and/or perturb the power supply grid in embodiments of the invention.

The determined values resulting from a determination of one or more electrical quantities can be determined from measured values of one or more measurement devices. Theses measurement devices can be the measuring devices of the power source or the system according to embodiments of the invention or can be arranged remotely therefrom, e.g., somewhere in or at the power supply grid.

The determination can happen in the measurement device, the measuring device, the computing device, and/or other devices in signal communication with some or all of the above.

The determination of the electrical quantities can happen with measurements of non-electrical quantities. As mentioned before changes of operating parameters, e.g. boost pressure, of an internal combustion engine can for example be used to determine a change in mechanical power and hence a change of the electrical power of the grid. It might even be possible to measure the mechanical power output of the engine itself.

Further advantageous embodiments of the invention are defined in the dependent claims.

It can be provided that as at least one parameter or in addition to the at least one parameter a grid inertia parameter and/or a grid damping parameter is derived from the measured values and/or the determined values, preferably wherein the grid inertia parameter is indicative of the collective inertia of the at least one power source and the at least one power consumer and/or wherein the grid damping parameter is indicative of a load damping of the power supply grid.

The grid damping parameter could also be called load damping parameter or grid stiffness.

In preferred embodiments of the invention, adapting the control of the at least one power source includes using the grid inertia parameter and/or the grid damping parameter for the adapted control.

In preferred embodiments of the invention, the at least one parameter comprises a collective proportional grid control parameter and/or a collective integral grid control parameter and/or a collective derivative grid control parameter.

In the following, a preferred embodiment of the invention is described in which a collective proportional grid control parameter and/or a collective integral grid control parameter and/or a collective derivative grid control parameter is determined.

Denoting the power balance Δ=(Σ_{M}−ΣP_{L}), the Swing Equation mentioned in the introductory part can be modified to read (in normalised form):

$$\frac{d Δ f}{dt} = \frac{1}{2 H} ( Δ P - {K}_{p} Δ f - {K}_{I} {\int }_{{t}_{0}}^{t} Δ {fd}_{τ} - {K}_{D} \frac{d Δ f}{dt} - D Δ f )$$

where K_{P} is a collective proportional grid control parameter, K_{I} is a collective integral grid control parameter, and K_{D} is a collective derivative grid control parameter. As is evident, these parameters describe contributions to collective control or governor behaviour of the power supply grid.

Analyses conducted by the Applicant have shown that the modified Swing Equation given above models a wide variety of grids with a wide variety of controlled participants quite well.

The modified Swing Equation given above therefore could be called 2^{nd} Order Swing Equation or 2^{nd} Order Grid Model.

In other embodiments according to the invention, the (1^{st} order) Swing Equation given in the introduction could also be used.

In other embodiments of the invention, other modifications of the Swing Equation can be used. For example, if a set of participants of a grid can be modelled well by a specific model M(Δf), this term could be used to modify the Swing Equation in addition to or instead of one or all of the terms in connection with K_{P}, K_{I}, and K_{D}.

The 2^{nd} Order Swing Equation given above as a second order differential equation can also be written as the system of two first order differential equations given below:

$$\frac{d δ}{dt} = \frac{f - {f}_{N}}{{f}_{N}} = Δ f$$

$$\frac{d Δ f}{dt} = \frac{1}{2 H + {K}_{D}} ( Δ P - ( {K}_{P} + D ) Δ f - {K}_{I} δ )$$

Here, δ could be interpreted as a normalized load angle, but is just used as an auxiliary quantity.

By Laplace-transforming this system of first order differential equations a (2^{nd} order) transfer function can be derived as:

$$\frac{Δ f}{Δ P} = \frac{s}{( 2 H + {K}_{D} ) {s}^{2} + ( {K}_{P} + D ) s + {K}_{I}}$$

2H+K_{D} could be interpreted as sum of physical (2H) and (virtual) governor (K_{D}) inertia in the power supply grid. The governor inertia can be viewed as the inertia which the power supply grid exhibits because of the actions of controllers of participants of the grid.

K_{P}+D could be interpreted as the proportional reaction on frequency deviations, resulting from physical load damping effects and the proportional reactions of the controllers of the participants of the grid (governor reaction).

It should be noted that, in some embodiments of the invention, the parameters K_{P} and/or K_{P} are determined by themselves. In other preferred embodiments, the at least one parameter can be the grid inertia parameter and/or the grid damping parameter, e.g., 2H+K_{D} and/or K_{P}+D.

As mentioned before, deriving the grid inertia parameter and/or the grid damping parameter can be done as the at least one parameter according to embodiments of the invention or in addition to the at least one parameter according to embodiments of the invention.

The at least one parameter can be determined from measured values and/or determined values, such as the frequency deviation Δf and the power imbalance ΔP.

In preferred embodiments, a plurality of measured values and/or determined values can be used in order to determine the at least one parameter more accurately.

Preferably, the electrical quantities are those parameters that are used in the differential equations, e.g., as given above, that describe the dynamic grid response. In other words, the electrical quantities are quantities which have a counterpart in the dynamic grid response model.

For determining the at least one parameter, for example, a recursive least squares method can be used which is in and of itself known.

It can be provided that the power supply grid before and/or during the time period is actively excited and/or perturbed by modifying the power output of the at least one power source and/or modifying the power consumption of the at least one power consumer.

The modification of the power output and/or power consumption can, for example, be done in the form of a stepped or ramped increase or decrease of the power. Other form of changing the power with a smooth curve or a modulation are also conceivable.

In practice, it can be difficult to determine certain global parameters of the power supply grid, such as the power imbalance ΔP. Actively perturbing or exciting the power supply grid can therefore be advantageous, because it may be performed with a known power source or power consumer, such that for example the change in power, in particular the power imbalance ΔP, is known quite accurately.

Especially in large power supply grids, it can be advantageous to choose the time period to be quite short. This makes it less likely that power changes stemming from unknown parts of the grid affect the measurement of the electric quantities of the power supply grid.

The time period can preferably be shorter than 1 s or shorter than 0.5 s or shorter than 0.3 s.

Preferred durations for the time period can be between 100 ms and 1000 ms, preferably between 200 ms and 300 ms.

It can be provided that the power supply grid is excited and/or perturbed by modifying the power output of a genset, preferably using skip firing of at least one cylinder of the genset and/or changing or forcing a position of a compressor bypass valve and/or exciting a generator voltage.

Skip firing means that one or more cylinders of an internal combustion engine is/are prevented from firing for a certain (usually short) time span, for example, by switching off the ignition and/or the injection of fuel.

As a consequence, the mechanical torque and therefore the power output of the engine will drop during this time span, thereby causing an excitation and/or a perturbation of the power supply grid.

Quantitatively, the change in power (power imbalance) can be estimated as:

$$Δ P = - \frac{{P}_{G , 0}}{{P}_{N}} * \frac{{N}_{skip}}{{N}_{cyl}}$$

Where P_{G,0} is the measured local generator power of the genset at the time just before triggering the excitation and P_{N} is the nominal power of the genset. Nₛₖᵢₚ is the number of skipped cylinders and N_{cyl} is the number of total cylinders of the genset. For example, if the genset has 12 cylinders and one of them gets skipped, the resulting power change is determined as:

$$Δ P = - \frac{{P}_{G , 0}}{12 {P}_{N}} .$$

Alternatively or additionally to skip firing, the power of a genset can for example be also modified by changing or forcing the position of a compressor bypass valve or by exciting the generator voltage of a (e.g., synchronous) generator of the genset.

By opening (or otherwise changing position or forcing) the compressor bypass valve of a turbocharged internal combustion engine of a genset for a (preferably short) time span, the intake manifold pressure and therefore the power will drop during this time span. As described above, this power drop can be seen as global power disturbance of the grid during the excitation time span. Based on the assumption, that the air-fuel ratio A stays constant for the short excitation time span, ΔP is considered to be proportional to the product of intake manifold pressure pᵢₘ and frequency f. It can be estimated as:

$$Δ P = \frac{{K}_{0} {p}_{i m} f - {K}_{0} {p}_{i m , 0} {f}_{0}}{{P}_{N}}$$

where K₀ describes the proportional coefficient at the time just before triggering the excitation. K₀ calculates as:

$${K}_{0} = \frac{{P}_{G , 0}}{{p}_{im , 0} {f}_{0}}$$

where P_{G,0}, p_{im,0} and f₀ are measured at the time just before triggering the excitation.

Regarding exciting of the generator voltage, it can be referred to Junbo Zhang, Hanchen Xu—“Online Identification of Power System Equivalent Inertia Constant”—IEEE Transactions on Industrial Electronics, Vol. 64, No. 10, October 2017.

The time span for which the power output of the power source is modified may be the same as the period of time according to embodiments of the invention or different.

The modification of the power output of the at least one power source can be performed for a single power source or for a plurality of power sources at the same time or at similar times.

For implementing the modification of the power output of the power source, the control unit can be in signal communication with the actuators mentioned.

The power source which is used for actively exciting and/or perturbing the power supply grid and the power source for which the control is adapted based on the estimated at least one parameter can be the same or different.

An estimated power modification of the at least one power source and/or the at least one power consumer can be used for deriving the at least one parameter of the dynamic grid response model.

In preferred embodiments of the invention, adapting the control of the at least one power source includes scheduling gains of the control and/or inputting the at least one parameter in a model of a model based controller, in particular a non-linear model predictive controller, or a state space controller.

Alternatively or additionally, other controller types, preferably optimal controllers, can conceivably be used, e.g., a linear-quadratic regulator.

The control unit can be configured to adapt the control of the at least one power source by scheduling gains of the control and/or by using the at least one parameter in a model of a model based controller, in particular, a non-linear model predictive controller, or a state space controller.

Generally, controller types can be preferred which take into account the dynamic states of the power supply grid.

For an implementation of a model predictive controller, it is generally referred to Huber, Kopecek, and Hofbaur as mentioned in the introductory part of this description. They disclose a speed/frequency control approach for an internal combustion engine for a genset, preferably in island operation, based on a nonlinear model predictive controller. The algorithm of the model predictive controller computes control signals to track the reference speed in an optimal manner in terms of response time and actuating effort, subject to an underlying physical model. The model used therein is based on a differential relationship between power and frequency to compute optimal control signals for frequency stabilization. It has the form:

$$\dot{ω} = \frac{1}{J} ( \frac{{P}_{M} ( {x}_{E} )}{ω} - \frac{{P}_{G}}{ω} )$$

and includes the accumulated inertia of the internal combustion engine's crankshaft, coupling and generator J and the internal combustion engine's mechanical power production which depends on engine related states x_{E} (e.g., boost pressure). In the case of island operation, this equation can be interpreted as a dynamic grid response model of the single plant island grid.

To robustly use the controller presented by Huber, Kopecek and Hofbaur for frequency stabilization, for example in a weak grid with several small plants, a simple adaption strategy is to replace J in the equation above with an estimated inertia constant H, using the definition for H given in the introductory part of the description.

A further example of adapting the control of the power source would be to replace the model of Huber et al fully or partly by a 2^{nd} Order Grid Model as given above. This will be described in the sequel.

For this purpose, the coupled system of first order differential equations which constitute the 2^{nd} Order Swing Equation have to be rewritten in absolute form, i.e., not in normalised form. The second equation of the system then reads:

$$\frac{1}{{ω}_{N}} \frac{d Δ ω}{dt} = \frac{1}{2 \hat{H}} ( \frac{Δ \tilde{P}}{{P}_{N}} - {\hat{K}}_{P} \frac{Δ ω}{{ω}_{N}} - {K}_{I} \frac{\tilde{δ}}{{ω}_{N}} )$$

where Δ ω, Δ\tilde{P}, \tilde{δ} are unnormalized quantities. Obviously the normalised Δf is replaced by (Δω)/(ω_{N}) and 2H+K_{D} and K_{P}+D are replaced by 2Ĥ and \hat{K}_{P} for the sake of simplicity. Multiplying this equation by ω_{N} leads to:

$$\frac{d Δ ω}{dt} = \frac{{ω}_{N}}{2 \hat{H} {P}_{N}} ( Δ \tilde{P} - {P}_{N} {\hat{K}}_{P} \frac{Δ ω}{{ω}_{N}} - {P}_{N} {K}_{I} \frac{\tilde{δ}}{{ω}_{N}} ) .$$

Multiplying by (ω_{N})/(ω_{N})=1 on the right hand side leads to:

$$\frac{d Δ ω}{dt} = \frac{{ω}_{N}^{2}}{2 \hat{H} {P}_{N}} ( \frac{Δ \tilde{P}}{{ω}_{N}} - \frac{{P}_{N}}{{ω}_{N}^{2}} {\hat{K}}_{P} Δ ω - \frac{{P}_{N}}{{ω}_{N}^{2}} {K}_{I} \tilde{δ} ) .$$

Using the definition of H given in the introductory part of the description and choosing 2πf₀=ω_{N} and S_{N}=P_{N}, the factor ω²_{N}/(2ĤP_{N}) can be replaced by 1/J_{grid}. Obviously, dΔ ω/dt is equal to dω/dt, so the equation can be rewritten as:

$$\frac{d ω}{dt} = \frac{1}{{J}_{grid}} ( \frac{Δ \tilde{P}}{{ω}_{N}} - {\tilde{K}}_{P} Δ ω - {\tilde{K}}_{I} \tilde{δ} )$$

where \tilde{K}_{P}=(P_{N}/ω²_{N})*\hat{K}_{P} and \tilde{K}_{I}=(P_{N}/ω²_{N})*\hat{K}_{I} are unnormalized controller gains. J_{grid} represents the physical inertia value together with the derivative component of a collective controller response (virtual inertia or governor response) of the power supply grid.

Finally, the 2^{nd} Order Grid Model can be formulated such that it can directly serve as basis for the control disclosed by Huber et al:

$$\dot{\tilde{δ}} = ω - {ω}_{N}$$

$$\dot{ω} = \frac{1}{{J}_{grid}} ( \frac{{P}_{M} ( {x}_{E} )}{ω} - {\tilde{K}}_{P} ( ω - {ω}_{N} ) - {\tilde{K}}_{I} \tilde{δ} )$$

Discretising and implementing this model in a predictive controller according to Huber et all makes it possible to directly use the at least one parameter for adapting the control of the at least one power source.

Other ways of using the at least one parameter would be to time dependently schedule control gains of the at least one power source.

In a preferred embodiment, the controller gains yielding a stable system for at least 2 different grid inertia values (e.g., determined by simulation or experiments) are stored in a look-up table. For any estimated grid inertia value, the controller gains can be interpolated from this look-up table.

At least two of the following can be measured and/or determined as electrical quantities of the power supply grid: grid frequency and/or grid voltage and/or grid current and/or grid power and/or generator power and/or changes or change rates thereof, in particular a power disturbance (or power imbalance) of the grid.

In particularly preferred embodiments, the frequency of the grid is measured and a change in power of the grid is determined (e.g., from known data from actively exciting the grid).

The electrical quantities can be measured at the site and/or terminals of the at least one power source.

The measuring site (e.g., power source) and the site (e.g., power source) where the excitation and/or perturbation of the power supply grid is performed actively can be the same or different.

The computing device can be integrated into the control unit of the at least one power source.

### BRIEF DESCRIPTION OF THE DRAWINGS

Further details and advantages of the invention are apparent from the figures and the accompanying description of the figures. The figures show:

FIG. 1 illustrates a schematic of an embodiment of the system according to embodiments of the invention,

FIG. 2 illustrates a schematic of an embodiment of the power source according to embodiments of the invention,

FIG. 3 illustrates an exemplary schematic for the control of an embodiment of a genset according to embodiments of the invention,

FIG. 4 illustrates frequency and power diagrams showing a grid perturbation, and

FIG. 5 illustrates a diagram showing a grid perturbation.

### DETAILED DESCRIPTION

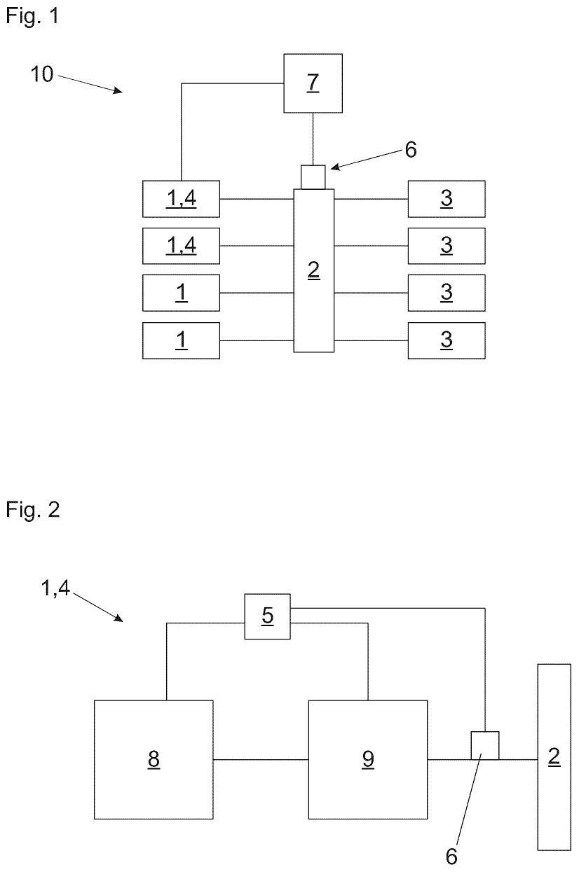

FIG. 1 shows a schematic of an embodiment of the system 10 according to aspects of the invention.

There is a plurality of power sources 1, in this case connected to the power supply grid 2.

The power sources 1 include respective control units 5 capable of controlling the operation of the at least one power source (see FIG. 2).

Some of the power sources 1 are gensets 4, others are different power sources.

There is a measuring device 6 for measuring the frequency f of the power supply grid 2.

The measuring device 6 is in signal communication with a computing device 7 and transmits the measured values of the frequency f to the computing device 7.

Power consumers 3 are connected to the power supply grid 2.

The number of power sources 1, in particular gensets 4, and power consumers 3 is purely exemplary in FIG. 1.

In this embodiment, it is envisioned that one of the gensets 4 actively modifies its power output in order to put the power supply grid 2 into an excited and/or perturbed state, e.g., employing skip firing, such that the change of the power or power imbalance can be estimated.

The time period in which the perturbation of the grid is performed can for example be in a range between 200 ms and 1000 ms long.

Because one of the gensets 4 is used to actively perturb the power supply grid 2, the change in power ΔP can be estimated from the known behaviour of the genset 4.

During the time period where the power supply grid is excited and/or perturbed, it is therefore known how the power changes (determination of the change of power) and from the measured values of the measuring device 6 how the frequency f deviates from a nominal frequency of the power supply grid 2.

The computing device 7 is also in signal communication with the control unit 5 of the genset 4, which performs the perturbation of the power supply grid 2.

The computing device 7 has therefore all the information necessary for deriving at least one parameter of a dynamic grid response model, e.g., K_{P}, K_{I}, K_{D}, 2H+K_{D}, K_{P}+D, as described before. These are indicative for a collective control response of the participants of the power supply grid 2 in this case.

The computing device is furthermore configured to output the at least one parameter and/or instructions for an adapted control of the power sources 1 based on the at least one parameter to the control units 5 of the power sources 1.

The functions of the computing device 7 can be integrated into the control unit 5 of a genset 4. Such an embodiment is schematically depicted in FIG. 2.

Operation of gensets 4 in synchronous AC grids 2 in many cases requires robust speed and power control strategies. In synchronous AC grids 2, the rotational speed of a synchronous generator 9 is synchronously coupled to the grid frequency f. Therefore, speed control of the engine 8 and generator shaft means frequency control of the grid 2.

Depending on the grid inertia, the control priority may shift between speed/frequency and power control. In case of a large public electricity grid 2, the grid inertia is usually much bigger than the inertia of the genset 4 (comprising engine 8, crankshaft, coupling, and generator 9). Operation in such a large grid 2 is referred to as grid parallel or mains parallel operation (MPO). In MPO, the control priority of a genset can be completely shifted to power control, because the speed of the plant will be imposed by the large grid 2.

In contrast to that, there is the mentioned isolated or island operation, where a genset 4 is supplying a single electrical load or a small number thereof on its own (or a small number of gensets). In this case, the power output of the plant is imposed by the load and the control priority completely shifts to speed/frequency control.

Between the two extreme cases of MPO and island operation, a genset 4 can operate in a weak grid as well, where for example several small powerplants and loads are connected. In such a weak grid or microgrid operation, speed and power control can be required simultaneously. If, for example, grid size or grid inertia changes over time (i.e. plants are disconnected or reconnected to the grid 2), the grid response characteristics change over time too. Speed and power control of the genset 4 must be robust against such time-variant grid response characteristics.

To improve controller robustness against time-variant grid response characteristics, it is obviously beneficial to identify these characteristics and adjust the control algorithm accordingly. In many cases of weak grid operation, there is no or not enough knowledge about other participants in the grid to identify the actual grid response characteristic parameters (e.g., grid inertia). In such cases, a method to estimate the actual grid response characteristics, by only using the available local measurements of the genset 4 is desirable.

FIG. 2 shows an embodiment of a power source 1 in the form of a genset 4.

The genset 4 comprises an internal combustion engine 8, here a gas engine, which drives a generator 9.

The measurement device 6 is arranged such that the electrical quantities of the power supply grid 2, e.g., the frequency f of the grid 2, can be measured at the site of the power source 1.

Again, the power source 1 is configured to actively excite and/or perturb the power supply grid 2, so that the control unit 5 has all the information necessary to derive the at least one parameter, e.g., K_{P}, K_{I}, K_{D}, 2H+K_{D}, K_{P}+D, as described before.

The described embodiments of the present invention therefore allow for the estimation of the grid response from the site of the genset 4 alone without the need to communicate or coordinate with any other participants of the power supply grid 2.

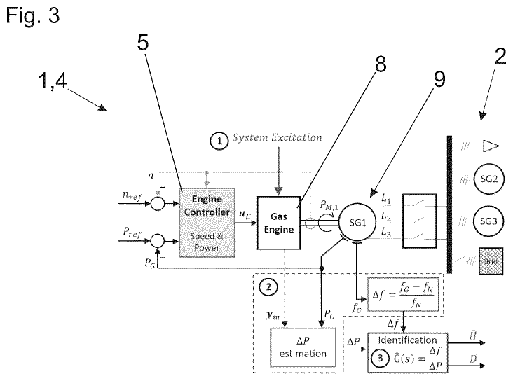

FIG. 3 shows an exemplary schematic for the control of an embodiment of a genset 4 according to aspects of the invention, preferably implemented in the control unit 5 of the genset 4.

The Engine Controller includes an engine speed control loop, which includes a comparison of a measured engine speed n to a speed reference n_{ref}. The speed reference n_{ref} is based on the nominal grid frequency, potentially corrected by frequency-droop or load-sharing line based setpoint shifts, i.e., n_{ref} is chosen such that the generator 9 driven by the gas engine 8 outputs electric power with a frequency which can be fed into the power supply grid 2.

The Engine Controller includes a power control loop, which includes a comparison of the power P_{G} measured at the generator 9. Alternatively or additionally, the comparison could also be based on a mechanical power P_{M,1} output by the internal combustion engine 8.

Based on the comparisons of the engine speed control loop and/or the engine power control loop, the Engine Controller controls actuators of the gas engine 8 with command values u_{E}.

The engine's 8 drive shaft drives the generator 9 which generates electrical power which is fed into the power supply grid 2.

An exemplary method according to embodiments of the invention includes the following three steps (circled numbers 1 to 3 in FIG. 3):
1) Triggering a suitable power excitation signal on the output of the gas engine 8 of the genset 4 (e.g., skip firing cylinders, force valve positions, excite generator voltage etc., see earlier description).
2) Estimating the resulting power disturbance AP in the grid and measure the frequency response Δf of the grid.
3) Apply an identification routine to compute at least one parameter of a dynamic grid response model (e.g., grid inertia parameter, grid damping parameter) using ΔP and Δf.

For the determination of ΔP and Δf, measurements of P_{G} and f_{G}, coming from a phase measurement unit (measuring device 6) of the genset can preferably be used.

Depending on the excitation method, further engine related signals yₘ, like an intake manifold pressure, may be necessary or beneficial.

Based on the grid response calculated in the third step, the Engine Controller of the internal combustion engine 8 can be adapted, e.g., using gain scheduling or an adaption of the model of a model predictive controller which is part of the Engine Controller.

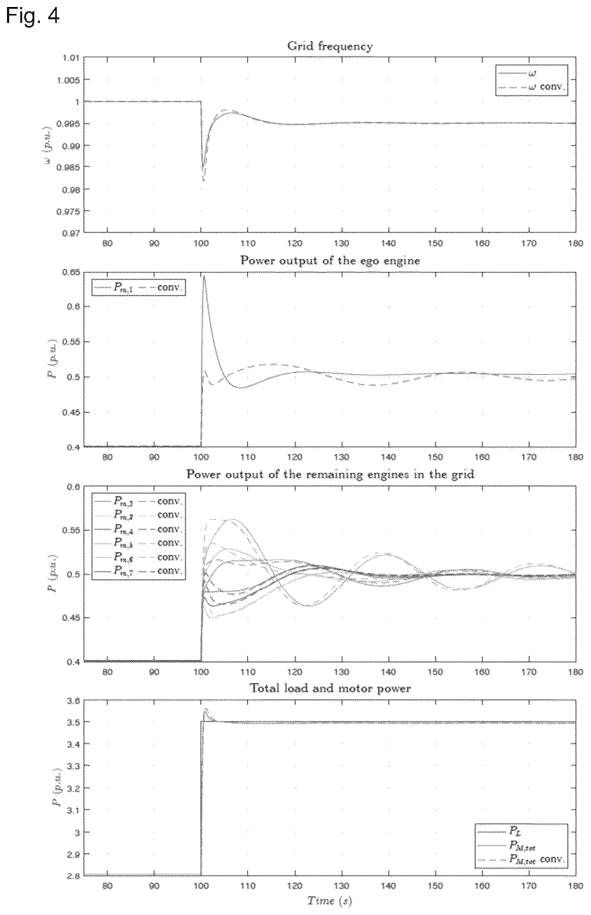

FIG. 4 shows results of a simulation of a weak grid with seven gensets 4 as power sources 1 and one load as power consumer 3. Concretely, the time diagrams of FIG. 4 show a grid frequency, a power output of a specific genset 4 (ego engine), a power output of the remaining engines, and a total load and engine (motor) power.

Generally, the diagrams show the plotted frequency with the specific genset 4 (ego engine) controlled according to embodiments of the invention (solid lines) and without the control according to embodiments of the invention (dashed lines).

The total load diagram shows a load step occurring at the 100 s mark, which leads to a dip in the grid frequency.

The specific genset 4 (ego engine) was controlled by a model based controller taking into account a dynamic grid response model according to embodiments of the invention. The diagram of the specific genset 4 shows a large power peak right when the load step occurs followed quick transition to an essentially constant power output. Clearly, the mentioned power peak is able to compensate a large portion of the load step. At the same, time the transition to an essentially steady state is faster compared to the conventional control (dashed line in the same diagram) and also compared to the remaining engines in the diagram below.

As a consequence, the dip and the back swing in the grid frequency shown in the first diagram is significantly smaller in the simulation according to embodiments of the invention (solid line) compared to the conventional approach (dashed line).

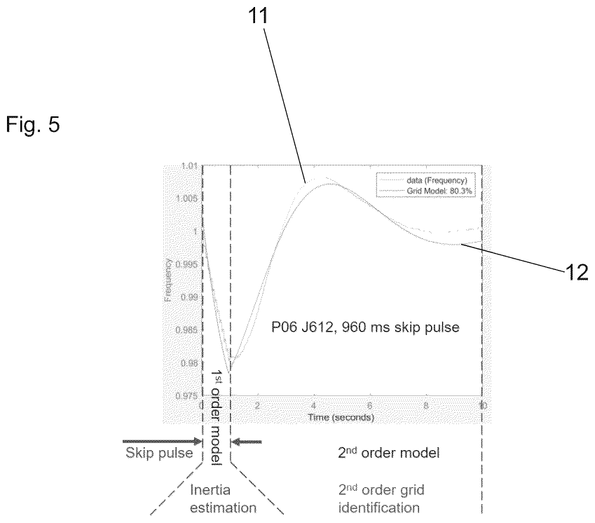

FIG. 5 shows a diagram of the grid frequency f of a power supply grid 2 taken from measurements of an engine test bench operated in an isolated grid (grey, curve 11) and an identified dynamic grid response model (blue, curve 12).

In order to show the effect of embodiments of the invention, the time span of the active grid excitation was chosen 960 ms long. As can be seen, the first unmodified Swing Equation mentioned in the introductory part (“1^{st} order model”) may model the grid response for a certain time. As soon as the controllers of the participants of the grid start to exert an influence on the frequency, the Swing Equation would not adequately model the grid 2 anymore.

Here the 2^{nd} Order Model taking into account the collective control response of the participants of the power supply grid 2 is much more accurate.

### LIST OF REFERENCE NUMERALS

1. power source
2. power supply grid
3. power consumer
4. genset
5. control unit
6. measuring device
7. computing device
8. engine
9. generator
10. system
11. curve measurement
12. curve identified model

1. A method for controlling at least one power source, the at least one power source supplying electrical power to at least one power consumer via an electrical power supply grid, the method comprising:
measuring and/or determining electrical quantities, comprising a frequency and a power disturbance, of the power supply grid during a time period where the electric power supply grid is excited and/or perturbed, such that there is a frequency deviation from a nominal frequency of the power supply grid;
deriving at least one parameter (H, D, K_{P}, K_{I}, K_{D}) of a dynamic grid response model from measured values and/or determined values of the measurement and/or determination of the electrical quantities of the power supply grid; and
adapting a control algorithm defining a control response of the at least one power source depending on the at least one parameter (H, D, K_{P}, K_{I}, K_{D}) of the dynamic grid response model.

2. The method according to claim 1, comprising deriving as the at least one parameter (K_{P}, K_{I}, K_{D}, H, K_{D}, K_{P}, D) or in addition to the at least one parameter (K_{P}, K_{I}, K_{D}, H, K_{D}, K_{P}, D) a grid inertia parameter (H, K_{D}) and/or a grid damping parameter (K_{P}, D) from the measured values and/or the determined values, wherein the grid inertia parameter (H, K_{D}) is indicative of the collective inertia of the at least one power source and the at least one power consumer and/or wherein the grid damping parameter (K_{P},D) is indicative of a load damping of the power supply grid.

3. The method according to claim 2, wherein the at least one parameter (K_{P}, K_{I}, K_{D}, H, K_{D}, K_{P}, D) comprises a collective proportional grid control parameter (K_{P}) and/or a collective integral grid control parameter (K_{I}) and/or a collective derivative grid control parameter (K_{D}).

4. The method according to claim 1, comprising actively exciting and/or perturbing the power supply grid before and/or during the time period by modifying the power output of the at least one power source and/or modifying the power consumption of the at least one power consumer.

5. The method according to claim 4, comprising using an estimated power modification of the at least one power source and/or the at least one power consumer for deriving the at least one parameter (H, D, K_{P}, K_{I}, K_{D}) of the dynamic grid response model.

6. The method according to claim 4, comprising exciting and/or perturbing the power supply grid by modifying the power output of a genset, using skip firing of at least one cylinder of the genset and/or changing or forcing a position of a compressor bypass valve and/or exciting a generator voltage.

7. The method according to claim 1, comprising measuring at least two of the following as the electrical quantities of the power supply grid: grid frequency and/or grid voltage and/or grid current and/or grid power and/or generator power and/or changes or change rates thereof.

8. The method according to claim 1, comprising measuring the electrical quantities at the site and/or terminals of the at least one power source.

9. The method according to claim 2, comprising adapting the control of the at least one power source using the grid inertia parameter (H, K_{D}) and/or the grid damping parameter (K_{P}, D).

10. The method according to claim 2, wherein adapting the control algorithm of the at least one power source includes scheduling gains of the control and/or inputting the at least one parameter (K_{P}, K_{I}, K_{D}, H, K_{D}, K_{P}, D) in a model of a model based controller or a state space controller.

11. A system configured to perform the method of claim 1, comprising
at least one power source, comprising a genset, for producing electrical power, wherein the at least one power source is configured for being connected to the electric power supply grid and wherein the at least one power source includes a control unit capable of controlling the operation of the at least one power source,
a measuring device configured for measuring and/or determining the electrical quantities of the power supply grid during the time period where the power supply grid is excited and/or perturbed, such that there is the frequency deviation from the nominal frequency of the power supply grid, and
a computing device configured for receiving measured values and/or determined values from the measuring device and for outputting data to the at least one power source,
wherein the computing device is configured to
derive at least one parameter (H, D, K_{P}, K_{I}, K_{D}) of the dynamic grid response model from the measured values and/or the determined values of the measurement and/or the determination of the electrical quantities of the power supply grid and/or from electrical quantities of the power supply grid determined otherwise, and
output the at least one parameter (K_{P}, K_{I}, K_{D}, H, K_{D}, K_{P}, D) and/or instructions for an adapted control of the at least one power source based on the at least one parameter (K_{P}, K_{I}, K_{D}, H, K_{D}, K_{P}, D) of the dynamic grid response model to the control unit of the at least one power source.

12. The system according to claim 11, wherein the computing device is integrated into the control unit of the at least one power source.

13. The system according to claim 11, wherein the genset comprises an engine for driving a generator by combusting a fuel and a control unit for the engine and/or the generator, wherein the control unit is adapted to receive as input:
at least one parameter (H, D, K_{P}, K_{I}, K_{D}) of the dynamic grid response model and/or
instructions for an adapted control of the at least one power source based on the at least one parameter (K_{P}, K_{I}, K_{D}, H, K_{D}, K_{P}, D) of the dynamic grid response model,
wherein the control unit is further configured to adapt the control of the engine and/or the generator based on the at least one parameter (K_{P}, K_{I}, K_{D}, H, K_{D}, K_{P}, D) of the dynamic grid response model and/or the instructions.

14. A non-transitory computer readable medium storing instructions executable by one or more processors, wherein the instructions are for controlling the at least one power source according to the method of claim 1, wherein the instructions cause the one or more processors to perform the following functions:
from a measuring device receiving measured values and/or determined values of the electrical quantities of the power supply grid during the time period where the power supply grid is excited and/or perturbed, such that there is the frequency deviation from the nominal frequency of the power supply grid, and
deriving the at least one parameter (H, D, K_{P}, K_{I}, K_{D}) of dynamic grid response model from measured values and/or determined values of the measurement or determination of the electrical quantities of the power supply grid, and
adapting the control algorithm defining the control response of the at least one power source depending on the at least one parameter (H, D, K_{P}, K_{I}, K_{D}) of the dynamic grid response model.

15. A controller having the instructions of claim 15 stored on memory and executable by one or more processors.

16. A method, comprising:
monitoring one or more electrical parameters of a power grid during a time period having an excitation and/or a perturbance of the power grid, wherein the power grid exhibits a frequency deviation from a nominal frequency during the time period;
deriving at least one parameter of a dynamic grid response model from the one or more electrical parameters of the power grid;
adapting a control algorithm defining a control response of at least one power source depending on the at least one parameter of the dynamic grid response model; and
controlling the at least one power source based on the control algorithm.

17. The method of claim 16, wherein the one or more electrical parameters comprise a frequency and a power disturbance.

18. The method of claim 16, comprising actively exciting and/or perturbing the power grid before and/or during the time period.

19. A system, comprising:
a controller configured to control at least one power source coupled to a power grid, wherein the controller is configured to:
monitor one or more electrical parameters of the power grid during a time period having an excitation and/or a perturbance of the power grid, wherein the power grid exhibits a frequency deviation from a nominal frequency during the time period;
derive at least one parameter of a dynamic grid response model from the one or more electrical parameters of the power grid;
adapt a control algorithm defining a control response of the at least one power source depending on the at least one parameter of the dynamic grid response model; and
control the at least one power source based on the control algorithm.

20. The system of claim 19, comprising the at least one power source comprising a combustion engine coupled to an electrical generator, wherein the one or more electrical parameters comprise a frequency and a power disturbance.
